(19) United States
(12) Patent Application Publication
(10) Pub. No.: US 2008/0245971 A1
(43) Pub. Date: Oct. 9, 2008

(54) Biosensors with Improved Sensitivity

(75) Inventors: Reinhold Wimberger-Friedl, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,943

(22) PCT Filed: Sep. 27, 2006
(86) PCT No.: PCT/IB06/53508

§ 371 Date: Apr. 2, 2008

(30) Foreign Application Priority Data
Oct. 3, 2005 (EP) 05109138.7

(51) Int. Cl. G01J 1/58

(52) U.S. Cl. 250/458.1

(57) ABSTRACT

A sensor is described for use with at least one optical detector (5), the sensor comprising a substrate (11) with optical outlets, a porous membrane (12) and micro fluidic channels (13) for conducting analyte fluid towards sensing locations (10) of the porous membrane (12). The sensing locations (10) are adapted for at least restraining light variable molecules (23) which bind to analytes to be determined. The optical output of the light variable molecules changes when they are in close proximity to a target molecule. The micro fluidic channels (13) are shaped to reflect light emitted from the sensing locations (10) towards the optical outlets and the substrate has diffracting optical elements (15) aligned with microfluidic channels to diffract light towards the optical outlets. The diffracting optical elements can be lenses.

The present invention relates to sensors especially biosensors suitable for making binding assays as well as methods of operating the same. In particular, it relates to a biosensor in which channels can be provided with capture probes to which analyte molecules can bind.

Sensitivity is of vital importance to any biosensing device. Optical detection (via fluorescence or chemiluminescence) is the gold standard in this field although other sensing methods are known. Typically glass or amorphous polymer substrates are used with immobilised capture probes attached to a first major surface thereof via particular coupling chemistry. The binding of labelled analyte molecules such as biological molecules to the probes is sensed or measured by the intensity of the light generated by labels, which become bound to the first major surface. The emitted light is sensed by a suitable optical sensor placed in a suitable geometrical relationship to the first major surface with the immobilised capture probes. If the sensor is placed facing the top of the substrate the sensor operates in reflective mode, if the sensor is placed below the substrate (facing a second major surface of the substrate remote from the first major surface with the immobilised probes) the sensor operates in transmissive mode. The light emitted from the probes propagates in all directions and only part of it can be projected onto a sensor surface. As a consequence of the proximity of the substrate to the sensor a significant portion of the light is coupled into the substrate and cannot reach a sensor independent of whether it is placed facing the first or second major surface (top or bottom) of the substrate. Therefore the yield of light energy to the sensor is even further reduced. Structured surfaces on non-porous substrates have been proposed in order to improve the light outcoupling.

The binding kinetics of biological molecules towards surfaces with the immobilised probes is limited due to diffusion limitation of the biological molecules in laminar flow. This slows down the speed of the measurement and consequently, since equilibrium sometimes is not reached, also the sensitivity of the sensor. To overcome this limitation, flow-through arrangements have been developed in which the capture probes are attached to microscopic channel walls located within the substrate. These microchannels run through the substrate, i.e. they run roughly perpendicular to the plane of the substrate. The analyte solution flows through these microchannels. Due to the very smell dimensions, the diffusion limitation is avoided and the specific surface area is increased dramatically. The result is that more labels can be captured per projected area to thereby increase the signal as for instance known from U.S. Pat. No. 6,635,493 to PamGene. The outcoupling of the light, however, can be affected by the heterogeneous structures.

As an alternative to the anisotropic pore structures in the PamGene design a random structures as present in filter membranes can be used for such a flow-through device. The capture probes and consequently the immobilised labels are distributed in the thickness direction of the membrane. The generated light has to pass through the scattering medium to reach the sensor surface. This process is rather inefficient. A lot of light is lost and/or contributes to a background level which then reduces the signal to noise ratio on the spots.

There remains a need for a biosensor with a porous membrane in which the sensitivity is improved.

It is an object of the present invention to provide improved sensors and especially biosensors and methods of operating the same, suitable for making binding assays, and in particular, an improved biosensor having channels where capture probes are attached for binding with the corresponding analyte molecules.

The above objective is accomplished by a biosensor and methods of operating the same according to the present invention.

The present invention provides a sensor for use with at least one optical detector, the sensor comprising a substrate with optical outlets, a porous membrane and microfluidic channels for conducting analyte fluid towards sensing locations of the porous membrane, the sensing locations being adapted for at least restraining light variable molecules which bind to analytes to be determined, wherein the microfluidic channels are shaped to reflect light emitted from the sensing locations towards the optical outlets and the substrate has diffracting optical elements aligned with microfluidic channels to diffract light towards the optical outlets.

The combination of diffracting elements such as lenses or gratings and shaped microfluidic channels increases the light efficiency of the sensor. The light variable molecules may be restrained in, trapped in, or be attached to the sensing locations of the porous membrane.

The sensor can have optical inputs for receiving light from a light source. This is useful when probes located at the sensing locations require an activating light source. The optical outlets can be the same as the optical inputs. This allows a compact design. To discriminate between source light and light emitted from the light variable molecules a selective filter may be used, e.g. a dichroic mirror.

Side walls of each microfluidic channel are preferably specular-reflective for the radiation emitted by the light variable molecules. The more efficient the side walls are reflecting light from the light variable molecules, the higher the optical efficiency of the sensor. To achieve reflectivity side and bottom walls of the microfluidic channels can be coated with a reflective material, for example the coating could be metal or could include metal.

The sensor may be constructed in a variety of ways, e.g. it can be made up of a sandwich of layers: the porous membrane having at least on one side thereof a layer in which the microfluidic channels are formed. An outer layer can be transparent and includes the optical diffracting elements as optical outlets and optionally as inlets. One embodiment of the present invention includes the microfluidic channels being prepared by dipping the porous membrane in a polymerisable solution and subsequently polymerised upon illumination through a mask of the desired design.

The side walls of the microfluidic channels are shaped to direct light towards the optical detector and may be in the form of a piece-wise smooth three-dimensional curve chosen from among paraboloid of revolution, semi-ellipse of revolution, semi-oval of revolution, hemisphere, semi-cylinder with a paraboloid cross-section, semi-cylinder with a semi-oval cross-section, semi-cylinder with a semi-elliptical cross-section, semi-cylinder with a paraboloid cross-section, semi-cylinder with a circular cross-section. These forms collect and guide the light hence increasing the optical efficiency of the biosensor. Within the framework of the present invention, the wording “at least a piece-wise smooth three-dimensional curve” is used to designate a curve which is not complete, since it is interrupted in the middle part of the microfluidic channel by the place left free for the sensing locations of the porous membrane.

Preferably, the microfluidic channels and the sensing locations are arranged into an array. Each sensing location may have its own separate supply of analyte fluid or groups of sensing locations may all receive analyte fluid from a single source. The microfluidic channels may be arranged so that sensing locations are supplied with analyte in parallel or in series.

Each sensing location is preferably surrounded by an opaque and/or reflective zone to reduce cross-talk between the sensing locations. The porous membrane may be filled with fluidly tight and optically reflective or opaque material.

When the sensor is a transmissive sensor an optical notch filter can be located on a wall of the sensor on a side of the porous membrane remote from the optical outlets, the notch filter allowing transmission of light from a light source but reflecting the light emitted from the light variable molecules. This can increase the amount of light from the light variable molecules which reaches the detector while also providing optical inlets for the source light.

The sensor according to the present invention can be a flow-through biosensor or a flow-over sensor. When the sensor is a flow-through sensor, the porous membrane can be arranged between microfluidic channels located on each side of the porous membrane. A reflective element can be located on a wall of the sensor on a side of the porous membrane remote from the optical outlets for reflecting light back to the sensing locations. In combination with a reflective coating on a wall of the substrate using shaped microfluidic on both sides of the porous membrane results in more light being returned to the optical detector.

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

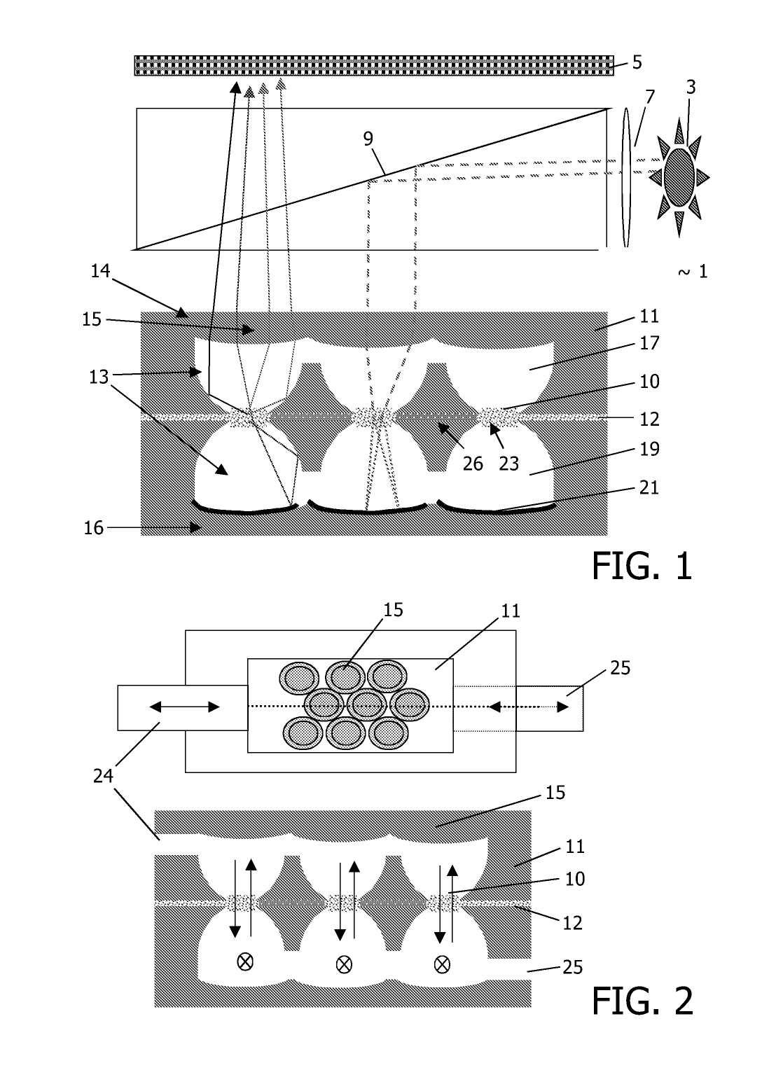

FIG. 1 is a vertical cross-section of a flow-through biosensor according to a first embodiment of the invention, used in reflective mode;

FIG. 2 schematically illustrates the fluid flow through the structure of FIG. 1:

FIG. 2A is a top view and FIG. 2B is a cross section;

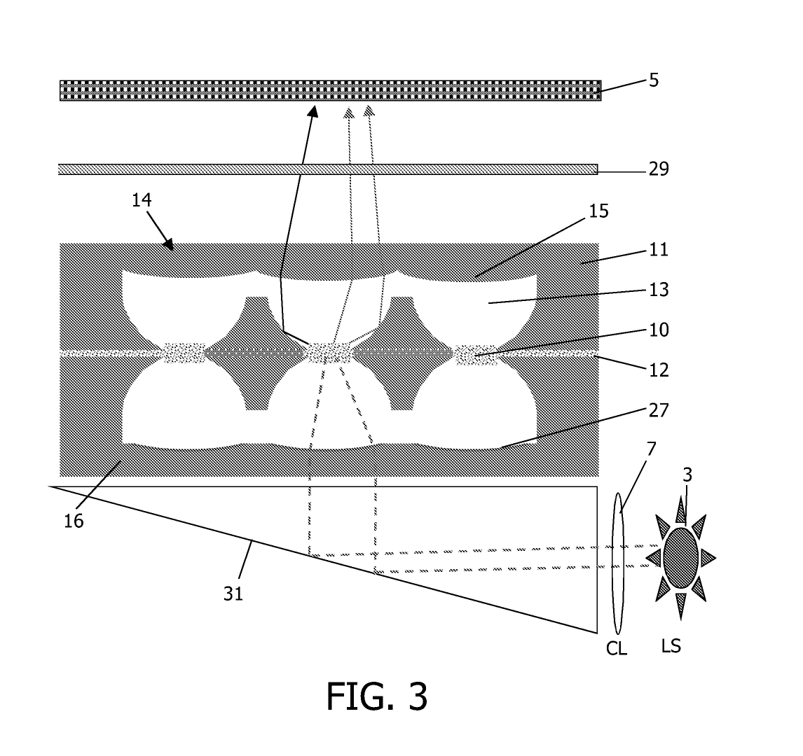

FIG. 3 is a vertical cross-section of a flow through biosensor according to a second embodiment of the invention, used in transmissive mode;

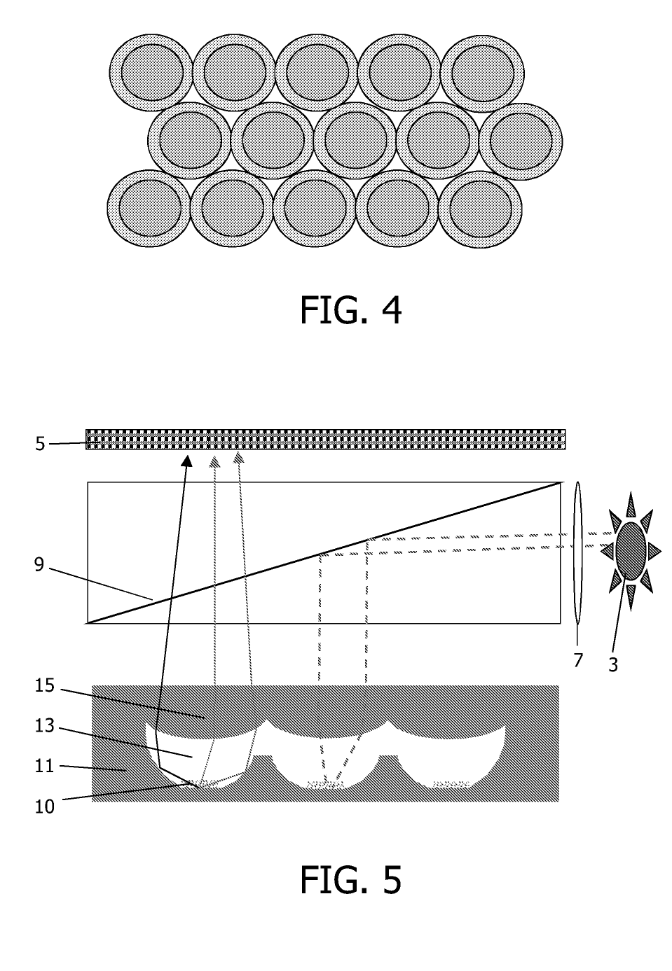

FIG. 4 is a schematic top view of a microfluidic channels arranged in an array and is an enlarged view of a part of FIG. 2;

FIG. 5 is a vertical cross-section of a flow-over biosensor according to a third embodiment of the invention.

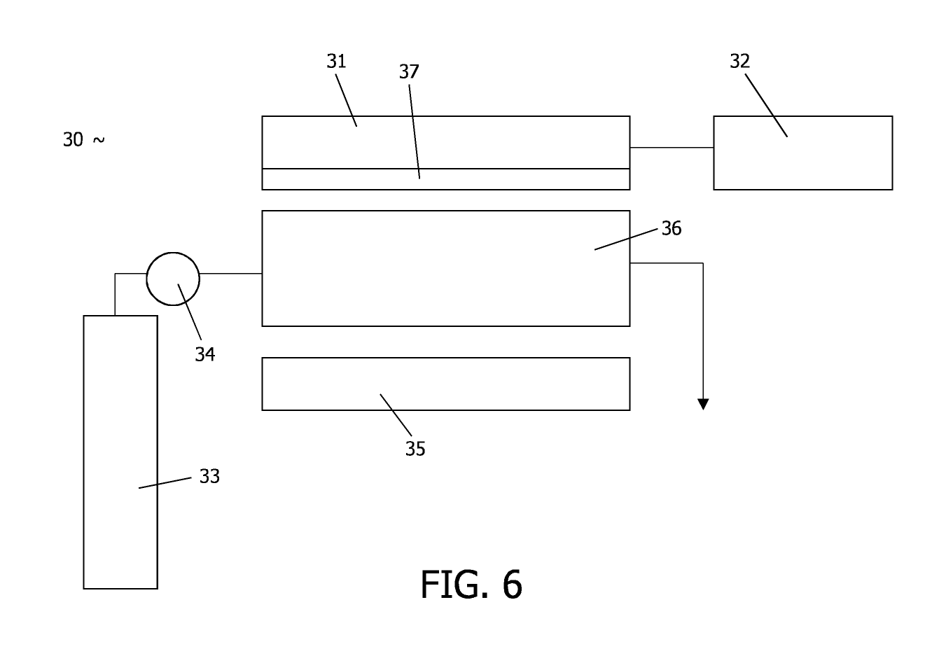

FIG. 6 is a biosensor arrangement according to a further embodiment of the present invention.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Further the present invention will mainly be described with reference to probes which are or include light variable molecules that emit light when in the presence of a target molecule. However the present invention is not limited thereto and can include probes which absorb light when in the presence of a target molecule. In this case an optical detector will detect the reduction in light intensity when the target molecule binds to the probe.

Other arrangements for accomplishing the objectives of the biosensors embodying the invention will be obvious for those skilled in the art.

The present invention relates to a sensor device especially a fluorescence or luminescence sensor device, e.g. luminescence biosensor or luminescence chemical sensor device. A sensor device according to the invention comprises a porous membrane, a substrate having microfluidic channels for directing fluid to sensing locations (spots) on and/or in the porous membrane, wherein the microfluidic channels are shaped not only to guide analyte liquid towards the sensing locations but also to act as reflective guides of light emitted from the sensing locations. Further the substrate has diffracting optical elements such as lenses or gratings, the diffracting optical elements and the reflective guides directing and concentrating the light emitted from the sensing locations towards optical outputs of the sensor. Lenses may be in any suitable form, e.g. lenticular, hemispherical, barrel, semicircular cylindrical, etc. An optical sensor or detector can be located opposite the optical outlets for determining the intensity and/or colour of the light exiting from the optical outlets. The optical detector can be any suitable detector including those with an electrical output but also those with any other recognisable output, e.g. the term optical detector includes a microscope. Both the lenses and the shaped microfluidic channels collimate the emitted light from the probes in the direction of the optical outlets of the sensor for receipt by an optical sensor or detector. The biosensor may be suitable for reflective or transmissive mode operation.

Materials may be provided to fluidly block and also to optically block or reflect emitted light going from probes in one sensing location to another, i.e. to prevent cross-talk. This may be achieved by making the walls of the microchannels 13 impervious to the analyte fluid and also opaque or reflective and by filling and sealing the porous membrane 12 at positions other than the probe locations, i.e. other than the sensing locations 10, with fluidly tight and opaque or reflective material.

The biosensor maybe a flow through or a flow over sensor. In the flow through sensor the microfluidic channels direct analyte fluid through the sensing locations of the porous membrane. The microfluidic channels can be arranged to prevent flow from one sensing location to another, i.e. the sensing locations receive analyte fluid in parallel. Alternatively, the analyte fluid flow may be from one sensing location to another, i.e. the sensing locations are arranged in series. In one embodiment of the present invention the direction of analyte flow through the sensing locations is along substantially the same axis as the light emitted from the locations travels to the sensor or detector. The microfluidic channels on the fluid entry side of the sensing locations and/or on the fluid exit sides of the sensing locations preferably shaped such as to be reflective guides. The detector may be placed on the same side of the biosensor as the light source (reflective mode) or may be placed on the opposite side (transmissive mode). In such an arrangement the porous membrane may be sandwiched between two pieces of substrate, each piece of substrate including shaped microfluidic channels. In the flow over sensor the microfluidic channels direct analyte fluid to flow over the sensing locations of the porous membrane along an axis substantially perpendicular to the axis of the light emitted from the probes at the sensing locations.

Probes are temporarily trapped or held or permanently trapped, held or attached to locations of the porous membrane. By temporarily held is meant that the porous membrane may restrain particles such as microbeads to which the probes have been attached. The restraint can be mechanical, chemical, electrical or magnetic. Examples are as follows: the porous membrane may act as a mechanical filter, e.g. having a pore size smaller than the microbeads while still allowing analyte biological molecules to pass through. The porous membrane may include magnetic material or a magnetic filed may be applied and the restraint of the magnetic microbeads is by magnetic attraction. The porous membrane may be electrically charged or be placed in an electric field and the restraint of insulating microbeads is by electrical attraction. The advantage of temporary holding of the probes is that by reversing the flow the probes can be removed and replaced by others. By permanently held or attached is meant that the probes are secured by any suitable positive form of attachment such as by van der Wahl's forces, covalent bonding, cross-linking, etc. The advantage of permanent attachment is that the biosensor may be reused for the same assay many times.

It is not anticipated that the present invention is limited by probe design, target molecule design, capturing methods or binding processes nor by the type of molecule or entity which is to bind to the probes. The binding entity can, for instance, be biotargets, that is molecules such an antibodies, proteins, nucleic acids (DNA or RNA), polynucleotides, peptides, carbohydrates, or may be a larger entity such as cells, parts of cells such as external or internal cell membranes, Golgi bodies, etc., or may be organisms such as bacteria, protozoa, viruses, etc. as required. The prorous membrane can be designed so that the biotargets pass through the membrane unless they bind to the probes.

The design of microfluidic channels as reflective guides improves optical signal output resulting from binding of chemical target molecules or biotargets, e.g. molecules, cells, cell parts, organisms as discussed above, to trapped, held or immobilized capture probes at the sensing locations on the porous membrane. The sensitivity of the sensor depends among others on the efficiency of the light outcoupling from the membrane to the sensor. By packaging the membrane between specially designed channel plates the outcoupling is improved dramatically. The microfluidic channels including the optical structures also serve as fluidic channels to guide the analyte through the porous membrane. The efficiency is improved by (i) forming in, or attaching collimating structures to the porous substrates, (ii) shaping parts of the substrate to act as diffractive optical elements such as lenses. Optionally, (iii) the areas between the sensing locations (spots) may be blocked against the transmission of fluid between sensing locations 10 and transmissions of scattered light from the probes to reduce the cross-talk between spots and reduce the background radiation.

A first embodiment of the biosensor of the invention is illustrated schematically in FIG. 1. The biosensor 1 is to be used as a flow-through device, and in a reflective mode, i.e. a light source 3 and a detector 5 are on the same side of the biosensor. Optionally, the source light, e.g. infra-red light, passes through a collimator 7 and a dichroic mirror 9. The purpose of the dichroic mirror is to reflect radiation at the source wavelength, e.g. infra-red, through optical inlets of the biosensor towards the sensing locations 10 in a porous membrane 12 but to allow through light emitted from the sensing locations, e.g. chemoluminescent or fluorescent light from the labels (23), so that this light reaches the optical detector 5. Light from the source 3 that is reflected from the dichroic mirror 9 is focused through diffractive optical elements, e.g. lenses 15 in a substrate 11 onto the sensing locations 10 of the porous membrane 12 wherein the capture probes are held or immobilized. The lenses 15 may be set into the substrate 11 or may be formed from it, e.g. by machining or moulding in the lenses, in any suitable manner. These diffracting elements are aligned with the microfluidic channels 13 and the sensing locations (10) on the porous membrane (12).

FIG. 1 shows three microfluidic channels 13 which belong to the same array in the substrate 11. These channels 13 are delimited by side, top and bottom walls which are preferably reflective and shaped in such a way as to guide the emitted light from the probes at the sensing locations towards the detector 5 or towards a mirror which then reflects this light towards the detector 5.

As can be seen in FIG. 2, the analyte to be analysed is introduced to the biosensor through inlet conduit 24 and leaves through conduit 25. Various flow arrangements are included within the scope of the invention, e.g. that each sensing location 10 with its associated microfluidic channels 13 can have its own separate inlet conduit 24 and/or outlet conduit 25. Alternatively groups of sensing locations 10 may be fed through a manifold from a single inlet conduit 24. Any suitable arrangement of analyte flow is included within the scope of the present invention and the flow of the analyte to be analysed by the binding assay can enter and leave the channels 13 in a sideways direction whereas the flow through the sensing locations is perpendicular to this direction as shown in FIG. 2. Other flow patterns are possible and there can be interconnections between adjacent microfluidic channels 13. The present invention includes a controller for programming which of the conduits 24 and/or 25 will be fed commonly. To achieve this microfluidic valves are placed within the conduits 24 and/or 25. Microfluidic valves and methods of manufacturing and activating them are known to the skilled person and will be described here in detail.

As is illustrated for the channel 13 at the middle of the FIG. 1, the source light passes through the collecting lens 15 formed or set in the top wall 14 of the substrate 11. In this embodiment, the channels 13 comprise each an upper part 17 on the fluid entry side of the sensing locations 10 and a lower part 19 on the fluid exit side of the sensing locations 10. As shown for the middle channel 13, source light passes through the sensing locations 10 of the porous membrane 12. Optionally, source light as well as light emitted from the probes at the sensing locations 10 is then reflected on a curved reflective bottom layer 21 formed or set into the back wall 16 of the substrate 11. The reflective layer can be any suitable layer, e.g. an evaporated or sputtered on metal layer such as aluminium. The light is reflected back to the porous membrane 12.

As will be better understood when referring to the channel 13 at the left part of FIG. 1, the shape of the walls of both the lower part 19 and the upper part 17 of the biosensor are designed in such a way that they act as collimating devices for the radiation which is emitted from the labels 23 at the sensing locations 10 in the porous substrate 11. In the embodiment represented in FIG. 1, the walls of the upper part 17 substantially form a paraboloid of revolution. The walls of the lower part 19 also form such a paraboloid. The shape of the walls could be modified, provided that the function of guiding the light towards the detector 5 is preserved, e.g. the walls could be tapered, be semi-circular, semi- elliptical or semi-oval in cross-section (narrowing as they reach the sensing locations 10 in each case). The walls could be in the form of a horizontal semi-cylinder open at the top towards the diffracting optical elements, e.g. lenses, the semi-cylinder being parabolic, semi-elliptical, semi-circular, tapered or semi-oval in cross-section (again narrowing as they reach the sensing locations 10). In the latter designs the light from the probes at the sensing locations 10 would be focussed more to a line than a point at the detector 5. This can be compensated by use of cylindrical or barrel lenses whose cylindrical axis is perpendicular to the axis of the semi-cylindrical microchannels, i.e. crossed axes.

Light emitted from the probes at the sensing locations 10 which is travelling approximately in the direction of the detector, is reflected by the side walls of the upper part 17 of channels 13 towards the detector 5 and is further collimated by the lenses 15. The radiation, which is emitted in the direction opposite to the detector 5 is reflected by the side walls of the channel 19 and then reflected by the reflective layer 21 at the bottom of the fluidic channel 13 back towards the detector 5. This light which is emitted from the probes at the sensing locations going away from the detector 5 is collimated towards the reflective surfaces 21 (or towards another detector if desired) by the shape of the lower parts 19 of the channels 13. Once the light has been reflected onto the concave reflective bottom layer 21, it is further reflected on the side walls of the lower part 19 and then on the side walls of the upper part 17, until it passes through the top wall 14 of the substrate which includes the collecting lens 15 and finally reaches the detector 5. Light is concentrated on the detector and, as a result, the sensitivity of the biosensor is improved.

To assist in the reflection of emitted light from the side walls of the microfluidic channels, these may be made reflective. For example, the substrate may be made up of two layers. The layer closest to the sensing locations 10 may be made of a reflective material such as a metal, e.g. aluminium or stainless steel. The microfluidic channels may then be conveniently machined in the metal layer. The outer layer is preferably made of a transparent material in which the lenses 15 may be set or formed. This material of this outer layer can be a clear plastic, glass, quartz, etc. Alternatively, the microfluidic channels may be manufactured with the walls 14, 16 and the lenses 15 or may be manufactured integrally with the porous membrane 12. In either case the walls of the channels 13 may be coated with a reflective coating, e.g. an evaporated or sputtered metal coating.

The light from the light source 3, which is not absorbed during the first passage through the sensing locations 10 of the porous membrane 12 is reflected and redirected by the reflective surfaces 21 towards the sensing locations 10 of the membrane 12 again to further increase the light intensity there.

In an embodiment of the present invention the porous membrane 12 is clamped between the upper and lower walls of parts 17, 19 of the microfluidic channel 13. The porous membrane can be compressed between the walls of the fluidic channels 13, as shown schematically in FIG. 1. In this way also radiation at extreme oblique angles can be collected while leakage of radiation to neighbouring sensing locations (spots) is minimised. This effect can be further improved by using an opaque or reflective material 26 which impregnates the porous membrane in areas which are outside the sensing locations. Material 26 can be loaded with suitable pigments such as carbon black or metal particles to make the material opaque or reflective, respectively. Such a material can be a light absorbing or reflecting glue or cement, which impregnates the porous substrates in the area in contact with the walls of the microfluidic channels, for example, but outside the sensing locations and then sets up and remains in position. Optical structures of the kind described with reference to the microfluidic channels can be moulded or replicated on to the substrate to improve the optical interface towards the optical elements.

Alternatively, a transmissive or a transmissive and reflective (i.e. detectors on both sides of the substrate) set-up can be employed with the biosensor flow-through device according to the present invention. A transmissive flow through biosensor is shown schematically in FIG. 3. The reflective layer 21 of FIG. 1 is either omitted or replaced by a notch filter 27 (e.g. a dichroic mirror), which transmits the light from the light source 3 but reflects the light from the labels. Additionally, between the fluidic channels 13 and the detector 5, a selective mirror 29 (e.g. a dichroic mirror) can be placed to reflect the light from the source 3 but transmit the light from the labels 23. There is no need for a dichroic mirror 9 as in the first embodiment of the invention, and a simple mirror 31 is sufficient.

Preferably, the labels on the probes which are trapped or held by, or are attached to the sensing locations 10 are capable of inducing a color reaction or a change of light intensity and/or capable of bio- or chemo- or photoluminescence or fluorescence when in the presence of the target molecules, e.g. they are fluorphores. All such molecules will be designated “light-variable molecules”. In the case that chemiluminescent or electrochemiluminescent labels are used or any other labels are used that emit light without being pumped by a separate source light, e.g. they can be pumped by environmental light, the set-up is similar to the one described with reference to FIGS. 1 to 3, except that light source 3, collimator 7 are not required. Mirror 9 or 31 also need not be used unless required to filter out stray light which has a different wavelength than the light emitted by the light variable molecules.

The design of the microfluidic channels 13 acting as optical structures is preferably optimised to have a high light-collection efficiency and at the same time a small projected area. The projected area is indicated in FIG. 4 (view from above the membrane 12). The aperture of the membrane 12 for the liquid should be high to have a compact detector unit and allow a large number of spots.

The biosensors according to the present invention may be constructed from materials conventional for microfluidic devices and micro total systems. In another embodiment the optical structures are prepared using a polymerisable solution. The porous membrane 12 is first dipped in such a solution to thereby form a layer of the material on either side of the porous membrane. The mixture is subsequently polymerised upon illumination through a mask of the desired design (e.g. holes). The polymerisable mixture should be chosen such that little or no polymerisation occurs in the non-illuminated areas. The pores will then be formed by self-stratification and the non-polymerised liquid can easily be washed out. The mask can be designed such that optical structures, e.g. the shaped microchannels, are formed similar to that described above (e.g. FIG. 1 or FIG. 3).

The self-stratifying mixture preferably contains reactive (i.e. polymerisable) and non-reactive substances. Upon polymerisation, the reactive substances will diffuse to the illuminated areas. Non-reactive substances will move in the opposite direction.

Advantages of the polymerisation option are increased (and tunable) mechanical strength of the membrane; flexibility (both in mask design as well in materials choice). Another advantage is surface modification: the polymerisable mixture can be designed such that additional functional groups are incorporated in the polymerised walls. These functional groups can be used for covalent attachment of capture probes inside the membrane. A further advantage is the control over wettability of polymerised walls.

Furthermore, both embodiments, i.e. the microfluidic channels having walls covered by reflective sheets and the channels having photopolymerized walls can be combined.

FIG. 5 illustrates a third embodiment, which is used as a flow-over biosensor. There is no bottom part 19 of the microfluidic channels, and the optical surfaces of the channels 13 can be integrated in the substrate 11 as well as the diffractive elements 15, e.g. lenses. Care has to be taken to have optimum flow conditions at the bottom surface of the channels 13, i.e. where the sensing areas 10 are located with the probes attached. The optical structures formed in the sides and walls of the channels 13 for reflecting light towards the optical outlets of the sensor preferably do not disturb the flow pattern too much otherwise convective material transport at the sensing surface 10 is reduced, which leads to a deceleration of the measurement and can introduce inaccuracies. The optical structures can be designed to reflect light in all directions (axial symmetry) or for an improved flow behaviour only in one direction (cylindrical symmetry) asz indicated above for other embodiments. The substrate can be, for example, an injection-moulded plastic part, which is metallised locally to create the reflective surfaces for the channels 13.

A biosensor arrangement 30 according to the present invention is shown schematically in FIG. 6 for transmissive flow through. A reflective arrangement is also included within the scope of the present invention. A source of analyte 33 is fed to biosensor 36 in accordance with the present invention, e.g. as decribed with reference to FIG. 3, via a pump 34 or gravity or capillary feed. The analyte will typically contain biomolecules or chemical entities to be detected by the biosensor. Optionally, a source of radiation 35, e.g. light, is located adjacent to the biosensor 36 to illuminate it with source light. Ambient lighting conditions may also be used to illuminate the biosensor 36. An optical detector 31 is located on one side of the membrane to record light output or color changes. The optical detector 31 can be an optical sensor or an array of such sensors or can be camera such as a CCD camera. The optical detector 31 may have an optical filter 37 to attenuate light from the light source 35 and to allow transmission of light emitted from light variable molecules such as chemiluscent or fluorescent probes in the sensing locations of the biosensor 36. Output electronics 32 are connected to the detector 31 by a wire, an optical fiber, or a wireless connection or any other suitable communications connection to process the output of the detector 31 and to provide a display output, alarms, hardcopy output, etc. as required.

Both reflective and transmissive biosensors can be used in accordance with the present invention. For sensitivity of the arrangement the effective collection angle of the emitted radiation is important. The optical detector can be immersed in the analyte liquid to avoid internal reflections.

Excitation intensities of the light source are related to the type of source and the field of illumination. For example, 0.1-1 W light sources can be used and can be any suitable type, e.g. LED, laser, etc. Preferably, the light sources should be selected to excite the light variable molecules, e.g. fluorphores to about half of the saturation intensity. The exposure time should be short to avoid photobleaching of the fluorphores. Hence pulsed light sources are preferred.

The biosensor arrangement of FIG. 6 may be integrated in a microfluidic device whereby the analyte flow may be driven by gravity feed, capillary action or by a microfluidic pump. The present invention also relates to a kit comprising any of the above mentioned biosensors. Such a kit may additionally comprise a detection means for determining whether binding has occurred between the probes and the analyte. Preferably, such detection means may be a substance which binds to the biomolecules in the analyte provided with a label. Preferably, the label is capable of inducing a color reaction and or capable of bio- or chemo- or photoluminescence or fluorescence.

The biosensors according to the invention may serve in a lot of applications, for instance for clinical diagnostic applications, as sensor for food quality and environment. When a biosensor according to the present invention is used to obtain nucleic acid sequence information, a large array of target areas is provided by an array of sensing locations 10 on the porous membrane 12, each sensing location including as a binding substance a DNA oligo probe of a different base-pair sequence. If a sample containing DNA or RNA fragments with a (partly) unknown sequence is brought into contact with the membrane a specific hybridisation pattern occurs, from which pattern the sequence of the DNA/RNA can be derived.

A biosensor according to the present invention may also be used to screen a biological specimen, such as blood, for any of a number of analytes. The array may consist of areas comprising DNA oligo probes specific for, for example, pathogens such as bacterial pathogens. If a blood sample is brought into contact with the device, the resulting hybridisation pattern can be read by the optical detector from which the presence of the bacteria can be inferred. A biosensor according to the present invention is suitable for the detection of viruses. In method is to detect single point mutations in the virus RNA.

A biosensor according to the present invention is also suited for performing sandwich immunoassays. In a sandwich assay a second ligand such as an antibody is used for binding to bound analyte. The second ligand is preferably recognisable, e.g. by use of a specific antibody.

Typical dimensions of the optical structures formed in the channels 13 are in the range between 50 and 1000 micrometer in the plane and between 10 and 500 micrometer in the thickness direction. The optical structures can be made of molded plastic, e.g. cyclo-olefinic polymers and -copolymers. In such a case, reflective parts are covered by a layer of evaporated Al. The semipermeable mirrors 9 and/or 21, 27 can be typically multilayer materials or cholesteric color filters. The detector 5 is any suitable detector or optical sensor such as a CCD or CMOS sensor array or camera. Each open part in the membrane can contain a different kind of capture probe to allow the analyis of a whole set of target substances or analytes, like oligonucleotides or proteins. They are useful for the detection of all analytes able to bind with a corresponding capture probe in a binding assay. These capture probes can be applied on the substrate by spotting technologies, like ink-jet printing, before or preferably after assembly with the collimating sheets. The composite membrane structure is attached to a channel system, which allows the introduction of sample liquid and other chemical liquids, which are required to carry out a biological test. These liquids can for instance be circulated sequentially or pumped forth and back to optimises the binding and measurement conditions.

It is to be understood that although preferred embodiments, specific constructions and configurations, as well as materials, have been discussed herein for devices according to the present invention, various changes or modifications in form and detail may be made without departing from the scope and spirit of this invention.

1. A sensor for use with at least one optical detector, the sensor comprising a substrate (11) with optical outlets, a porous membrane (12) and microfluidic channels (13) for conducting analyte fluid towards sensing locations (10) of the porous membrane (12), the sensing locations (10) being adapted for at least restraining light variable molecules (23) which bind to analytes to be determined, wherein the microfluidic channels (13) are shaped to reflect light emitted from the sensing locations (10) towards the optical outlets and the substrate has diffracting optical elements aligned with microfluidic channels to diffract light towards the optical outlets.

2. The sensor of claim 1, wherein the diffracting optical elements are lenses.

3. The sensor according to claim 1, wherein the sensor has optical inputs for receiving light from a light source (3).

4. The sensor according to claim 3 wherein the optical outlets are the same as the optical inputs.

5. The sensor according to claim 1, wherein side walls of each microfluidic channel are specular-reflective for the radiation emitted by the light variable molecules (23).

6. The sensor according to claim 5, wherein side and bottom walls of the microfluidic channels are coated with a reflective material.

7. The sensor according to claim 1, wherein the microfluidic channels are prepared by dipping the porous membrane in a polymerisable solution and subsequently polymerised upon illumination through a mask of the desired design.

8. The sensor according to claim 1, wherein side walls of the microfluidic channels are in the form of a piece-wise smooth three-dimensional curve chosen among paraboloid of revolution, semi-ellipse of revolution, semi-oval of revolution, hemisphere, semi-cylinder with a paraboloid cross-section, semi-cylinder with a semi-oval cross-section, semi-cylinder with a semi-elliptical cross-section, semi-cylinder with a paraboloid cross-section, semi-cylinder with a circular cross-section.

9. The sensor according to claim 1, wherein the microfluidic channels and the sensing locations are arranged into an array.

10. The sensor according to claim 1, wherein each sensing location (10) is surrounded by an opaque and/or reflective zone to reduce cross-talk between the sensing locations (10).

11. The sensor according to claim 1, wherein the sensor is a transmissive sensor and wherein an optical notch filter (27) is located on a wall of the sensor on a side of the porous membrane (12) remote from the optical outlets, the notch filter (27) allow transmission of light form a light source but reflecting the light emitted from the light variable molecules.

12. The sensor according to claim 1, wherein the sensor is a flow-through biosensor or a flow-over sensor.

13. The sensor according to claim 12, wherein the sensor is a flow-through sensor and the porous membrane (12) is arranged between microfluidic channels located on each side of the porous membrane.

14. The sensor according to claim 13, wherein a reflective element (21) is located on a wall of the sensor on a side of the porous membrane (12) remote from the optical outlets for reflecting light back to the sensing locations (1O).
